(19) United States
(12) Patent Application Publication
(10) Pub. No.: US 2007/0065642 A1
(43) Pub. Date: Mar. 22, 2007

(54) Device and method for thermoforming a part

(76) Inventors: Venkateswara Gupta, Bangalore (IN); Sunil Balakrishnan Earath, Bangalore (IN); Debananda Misra, Bangalore (IN)

Correspondence Address: Patrick S. Yoder;FLETCHER YODER, P.O. Box 692289, Houston, TX, 77269-2289, US

(21) Appl. No.: 11/233,324

(22) Filed: Sep. 21, 2005

(51) Int. Cl. B32B 3/00; B29C 49/78; B29C 51/46

(52) U.S. Cl. 428/156; 264/553; 264/322; 425/145; 425/522

(57) ABSTRACT

A method for thermoforming a part is provided. The method includes cutting a blank and masking at least one side of a desired surface of the blank with a flow-controlling material. The method also includes heating the masked blank to a forming temperature and forming the blank to achieve a desired contour of the part.

### BACKGROUND

The present invention relates generally to techniques for thermoforming a part, and more particularly, to control of thickness of a thermoformed part.

Various types of thermoformed parts are manufactured by a number of thermoforming techniques. Typically, thermoforming of a part includes heating a thermoplastic sheet or blank to a formable plastic state and subsequently applying air and/or mechanical assistance to shape it to the contours of a mold to achieve a desired shape. The strength and stiffness of a thermoformed part is governed, in part, by the minimum thickness of the part. In general, the material of the part is typically subjected to non-uniform bi-axial stretching. As a result, some features of the part may experience high thinning thereby leading to defective parts, or at least regions of reduced thickness and strength.

In some conventional thermoforming techniques, a required thickness of the part is achieved by controlling the sag of a sheet or blank. However, it is difficult to achieve the desired values of sag or plastic flow due to temperature limitations, temperature variations, and so forth. In certain other techniques, the thickness of the thermoformed part is achieved by controlling an applied temperature distribution via heating elements employed for heating the part. However, achieving a desired temperature distribution is challenging and may not be scalable to thermoforming of small parts. In certain thermoformed parts, the thickness of the preformed sheet may be increased to achieve the minimum thickness required in the final thermoformed part. However, manufacturing of parts using a preformed sheet having an increased thickness is relatively expensive. Further, a control of thickness in desired locations may be difficult to achieve.

Accordingly, there is a need for improved thermoforming techniques. Particularly, there is a need for a thermoforming technique capable of controlling the thickness of a thermoformed part in a straightforward and economical way, that can be employed with a wide range of part configurations.

### BRIEF DESCRIPTION

Briefly, according to one embodiment a method for thermoforming a part is provided. The method includes cutting a blank and masking at least one side of a desired surface of the blank with a flow-controlling material. The method also includes heating the masked blank to a forming temperature and forming the blank to achieve a desired contour of the part.

In another embodiment, a flow-controlling device for thermoforming of a part is provided. The flow-controlling device includes a flow-controlling material disposed on a sheet-like support and configured to control flow of a material at pre-determined locations on the sheet-like support during thermoforming of the part and an adhesive material disposed on at least the flow-controlling material and configured to couple the flow controlling material to the sheet-like support.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical illustration of a thermoformed part having a three-dimensional contour in accordance with aspects of the present technique;

FIG. 2 is a diagrammatical illustration of flow of material in a portion of the thermoformed part of FIG. 1 in accordance with aspects of the present technique;

FIG. 3 is a diagrammatical representation of an exemplary thermoforming process for manufacturing the part of FIG. 1;

FIG. 4 is a diagrammatical illustration of a preformed sheet for thermoforming a part in accordance with aspects of the present technique;

FIG. 5 is a diagrammatical illustration of a masked preformed sheet in accordance with aspects of the present technique;

FIG. 6 is a thermoforming system for thermoforming the masked sheet of FIG. 5 in accordance with aspects of the present technique;

FIG. 7 is a diagrammatical illustration of the thermoforming system of FIG. 6 having the masked sheet and a former in accordance with aspects of the present technique;

FIG. 8 is a diagrammatical illustration of the thermoforming system of FIG. 6 having heater elements for heating the masked sheet in accordance with aspects of the present technique;

FIG. 9 is a diagrammatical representation of a pre-stretched masked sheet in accordance with aspects of the present technique;

FIG. 10 is a diagrammatical illustration of an embodiment of the thermoforming process by the thermoforming system of FIG. 9 in accordance with aspects of the present technique;

FIG. 11 is a diagrammatical illustration of vacuum forming of the part via the thermoforming system of FIG. 10 in accordance with aspects of the present technique;

FIG. 12 is a diagrammatical illustration of the thermoforming system of FIG. 11 having a cooling device for the formed part in accordance with aspects of the present technique;

FIG. 13 is a diagrammatical representation of flow contours of a material of a thermoformed part manufactured by the thermoforming system of FIGS. 4-12 in accordance with aspects of the present technique;

FIG. 14 is a sectional view of the thermoformed part of FIG. 13 formed with and without masking of a sheet in accordance with aspects of the present technique;

FIG. 15 is a diagrammatical illustration of a thickness distribution of the thermoformed parts of FIG. 14 with and without the masking of the sheet in accordance with aspects of the present technique;

FIG. 16 is a diagrammatical illustration of a sheet of FIG. 4 in accordance with aspects of the present technique;

FIG. 17 is a diagrammatical illustration of a masked sheet of FIG. 5 in accordance with aspects of the present technique;

FIG. 18 is a diagrammatical representation of exemplary thickness distribution for thermoformed parts of FIG. 14 in accordance with aspects of the present technique;

FIG. 19 is a diagrammatical illustration of an exemplary flow-controlling material for masking a preformed sheet in accordance with aspects of the present technique;

FIG. 20 is a diagrammatical illustration of another exemplary flow-controlling material for masking a preformed sheet in accordance with aspects of the present technique; and

FIG. 21 is a diagrammatical illustration of a blow-molded part formed by using a flow-controlling material in accordance with aspects of the present technique.

### DETAILED DESCRIPTION

As discussed in detail below, embodiments of the present invention function to provide a technique for controlling thickness of a part fabricated by a manufacturing process such as thermoforming, blow molding and so forth. Although the present discussion focuses on processes such as thermoforming and blow molding, the present technique is not limited to these processes. Rather, the present technique is applicable to any number of suitable manufacturing processes where thickness control of the fabricated part is desired.

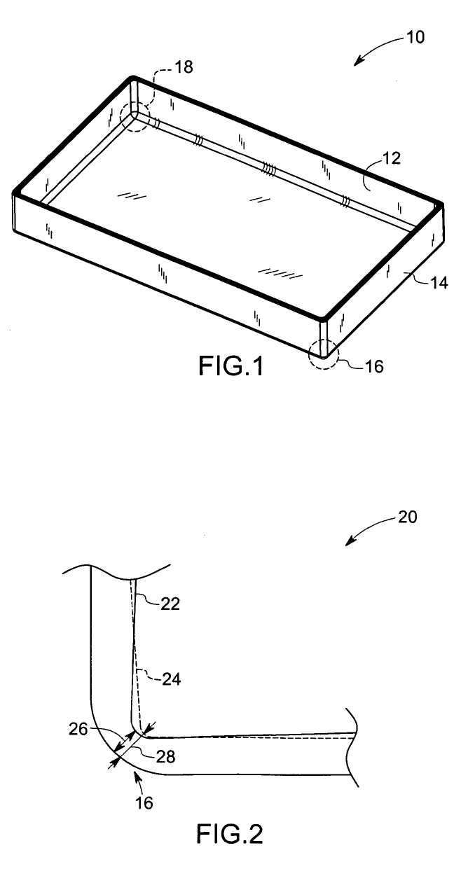

Turning now to drawings and referring first to FIG. 1 an exemplary thermoformed part such as a box 10 is illustrated. As illustrated, the thermoformed box includes a plurality of surfaces such as 12, 14 having a plurality of zones such as 16, 18 where thickness control is desired. The present technique provides a localized thickness control for maintaining a desired thickness profile in the plurality of zones 16 and 18 via a masking technique that will be described in a greater detail below.

FIG. 2 is a diagrammatical illustration of flow of material 20 in a portion of the thermoformed part of FIG. 1 in accordance with aspects of the present technique. In the illustrated embodiment, the flow of material in an area such as 16 formed by a thermoforming process is illustrated by flow contour 22 that is representative of the thickness profile in the area 16. Further, the desired thickness profile in this area is represented by the flow contour 24. As can be seen a thickness 26 measured in the part at a location may be substantially lower than a desired thickness 28 at the location. The present technique enables a desired thickness profile to be achieved or maintained in an area of interest by masking the area by a flow-controlling material as described below.

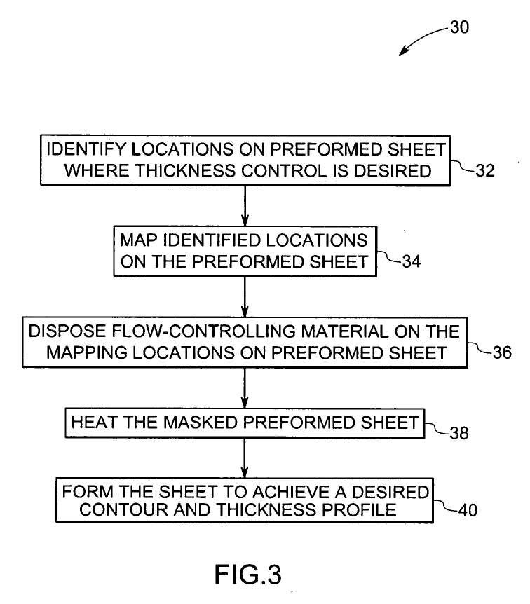

FIG. 3 is a diagrammatical representation of an exemplary thermoforming process 30 for manufacturing the part of FIG. 1 through a thermoforming system. As illustrated, the process 30 includes identifying locations on a preformed sheet or blank where thickness control is desired as represented by step 32. Examples of such locations include fillets, cavities, corners and so forth. As will be appreciated by those skilled in the art, such areas will often correspond to regions of higher plastic flow that are consequently subject to thinning beyond desired mechanical limits or tolerances. The identified locations are subsequently mapped on the preformed sheet or blank via any conventional mapping technique (step 34). As will be appreciated by those skilled in the art that mapping the identified locations on the preformed sheet or blank may include mapping the x-locations and y-locations from the formed shape on to the preformed sheet. In one embodiment, the mapping may be achieved through a finite element based model. However, other suitable mapping techniques may be envisaged.

Based upon the mapping, a flow-controlling material is disposed on the mapped locations on the preformed sheet as represented by step 36. The flow-controlling material is configured to control the flow of material at the mapped locations during thermoforming of the part. Next, the masked preformed sheet is heated to a desired forming temperature (step 38). In certain embodiments, the preformed sheet may be subjected to a non-uniform temperature distribution to achieve a desired thickness profile. In a present embodiment, heating elements along with a temperature control system are employed to control the forming temperature.

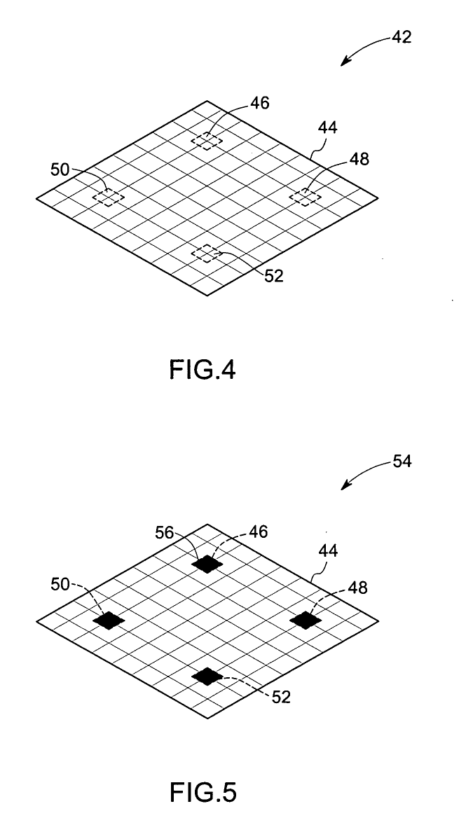

At step 40, the heated sheet is formed to achieve a desired contour and thickness of the thermoformed part. In one embodiment, the hot sheet is transferred into a vacuum forming chamber and the part is allowed to form and cool material over a mold in vacuum. Subsequently, vacuum may be released and the formed part may be removed from the thermoforming system. In certain embodiments, mechanical assists may be employed to facilitate shaping of the part to the contours of a mold. FIGS. 4-12 illustrate the steps of manufacturing a thermoformed part using the process of FIG. 3.

FIG. 4 is a diagrammatical illustration of a preformed sheet 42 for thermoforming a part in accordance with aspects of the present technique. As illustrated, the sheet 42 includes a surface 44 with a plurality of locations such as 46, 48, 50 and 52 where thickness control is desired. In the illustrated embodiment, four such locations are depicted. However, a greater or lesser number of thickness-controlled locations may be envisaged. In a present embodiment, the sheet 42 includes a thermoplastic material. The thermoplastic material for the formed part may be selected based on a number of factors such as the end use of the item, forming temperature and so forth.

In the illustrated embodiment, the pre-determined locations 46, 48, 50 and 52 are mapped on to the preformed sheet 42. As described above, any suitable mapping technique may be employed to map the locations 46, 48, 50 and 52 on the sheet 42. For example, a finite element model may be utilized to determine the x and y coordinates of the areas where thickness control is desired. The mapped locations on the preformed sheet 42 are masked with a flow-controlling material for controlling the flow of material during the thermoforming as shown in FIG. 5. It should be noted that as used herein the term “masking” refers to selective application of a flow-controlling material on the sheet 42 at pre-determined locations 46, 48, 50 and 52.

FIG. 5 is a diagrammatical illustration of a masked sheet 54 in accordance with aspects of the present technique. As illustrated, the surface 44 of the sheet 54 is masked with a flow-controlling material 56 at the pre-determined locations 46, 48, 50 and 52. In a present embodiment, the flow-controlling material 56 is coupled to the surface 44 via an adhesive material. In one embodiment, the flow-controlling material 56 includes an adhesive tape. For example, Kapton tape may be disposed at the pre-determined locations 46, 48, 50 and 52 to control the flow of material in these locations. The Kapton tape includes a polyimide film with heat resistant silicone adhesive to couple the tape to the surface 44. Such adhesive tapes are commercially available in the market.

In a presently contemplated configuration the melting point of the flow-controlling material 56 is relatively higher than the melting point of the material of the sheet 54. Moreover, the material of the flow-controlling material 56 and the sheet 54 is selected to withstand the stress due to the stretching during the thermoforming process. In certain embodiments, the shape and an orientation of the adhesive tape may be controlled to obtain a desired thickness profile. The masked sheet 54 having the flow-controlling material 56 is thermoformed in a thermoforming system as described below.

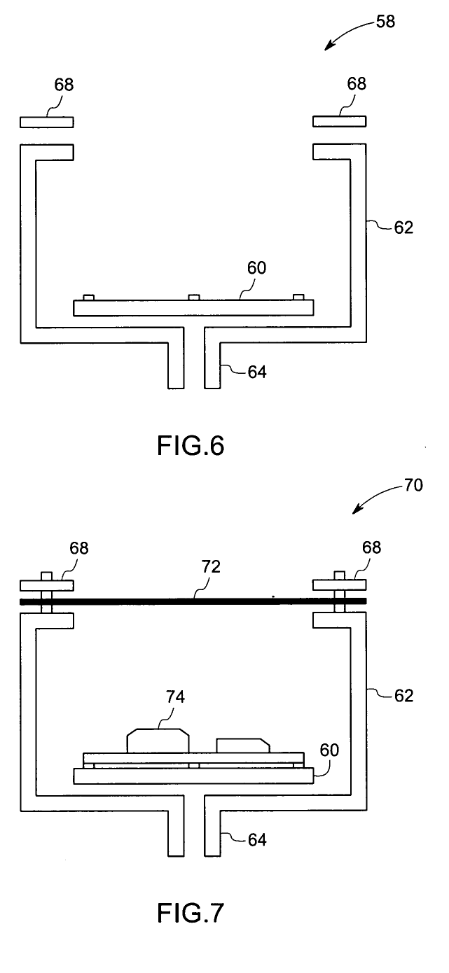

FIG. 6 illustrates an exemplary thermoforming system 58 for thermoforming the masked sheet 54 of FIG. 5 in accordance with aspects of the present technique. The thermoforming system 58 includes a moving table 60 disposed within a machine frame 62. The moving table 60 is configured to hold a forming mold. The thermoforming system also includes a suction port 64 for applying vacuum through forming mold in a vacuum thermoforming process. In a present embodiment, the thermoforming system 58 also includes clamps 68 to hold the masked sheet 54.

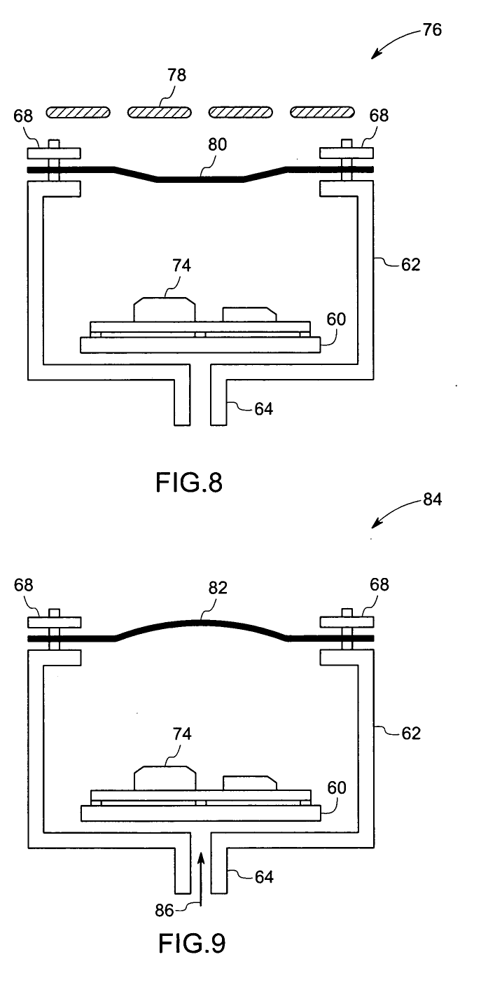

FIG. 7 is a diagrammatical illustration of the thermoforming system 70 of FIG. 6 having a masked sheet 72 and a forming mold 74. As illustrated, the masked sheet 72 having the flow-controlling material at pre-determined locations is clamped in the thermoforming system 70 via the clamps 68. Further, the forming mold 74 is disposed on the moving table 60 within a plenum chamber. The shape and size of the forming mold 74 may be selected corresponding to a desired shape of the thermoformed part fabricated by the thermoforming system 70. Further, the material of the forming mold 74 may be selected based upon factors such as forming temperature. In certain embodiments, the material of the forming mold 74 is aluminum. The masked sheet 72 is heated to a desired forming temperature via heater elements as illustrated in FIG. 8.

FIG. 8 is a diagrammatical illustration of an exemplary configuration 76 of the thermoforming system of FIG. 6 having heater elements 78 for heating the masked sheet 72 in accordance with aspects of the present technique. In this embodiment, the heater elements 78 are located above the sheet 72. Examples of such heater elements 78 include ceramic heaters, quartz tubes, lamps, quartz emitters, metal sheathed tubular heaters, open coil wire elements, flat faced panels and convection heater type ovens. In a present embodiment, the thermoforming system 76 includes heater elements 78 disposed on a top side of the sheet 72. Alternatively, the thermoforming system 76 may include heater elements 78 disposed on top and bottom sides of the sheet 72. Further, a temperature control system (not shown) may be coupled to the heater elements 78 to control the forming temperature. In a present embodiment, the heater elements 78 raise the temperature of the sheet 72 to the material glass-transition temperature, resulting in plastic bowing of the sheet 72 as represented by a deformed contour 80.

As described earlier, the flow-controlling material disposed on the sheet 72 locally controls the flow of material of sheet 72 during the heating process. More specifically, the flow-controlling material facilitates a thickness control at the pre-determined locations on the sheet 72 to achieve the desired thickness profile of the thermoformed part.

FIG. 9 is a diagrammatical representation of a pre-stretched masked sheet 82 in a thermoforming system 84. In the illustrated embodiment, air is blown into the plenum chamber 62 through the suction port 64 as represented by the directional arrow 86. This results in pre-stretching of the material of the sheet 82 before the forming mold 74 comes in contact with the sheet 82.

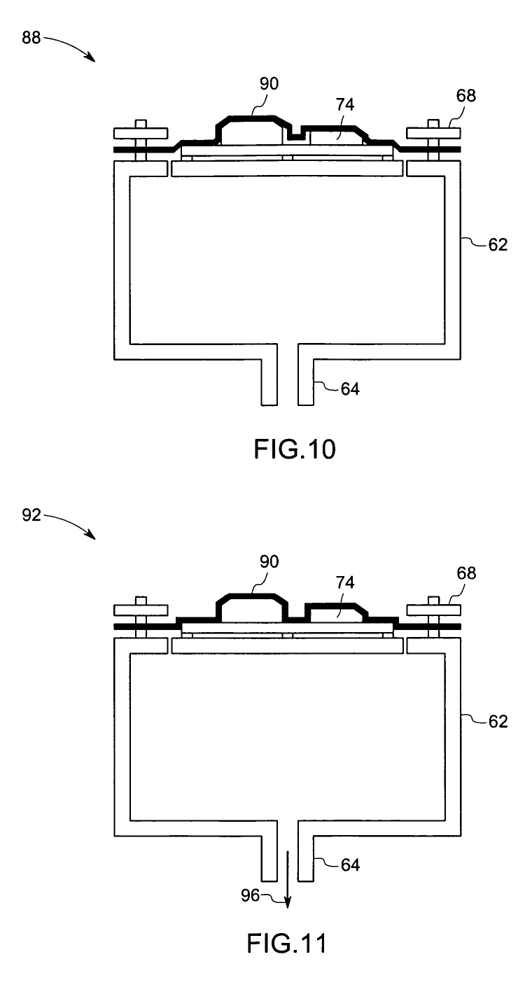

FIG. 10 is a diagrammatical illustration of an embodiment of the thermoforming process 88 by the thermoforming system of FIG. 9 in accordance with aspects of the present technique. In the illustrated embodiment, the moving table 60 along with the forming mold 74 is raised within the chamber 62 to make contact with the sheet 82 as represented by an exemplary configuration 90.

FIG. 11 is a diagrammatical illustration of vacuum forming 92 of the part via the thermoforming system of FIG. 10 in accordance with aspects of the present technique. In this embodiment, vacuum is applied through the forming mold 74 as represented by the directional arrow 96. As a result, the pre-stretched sheet 90 is drawn tightly to the forming mold 74 and thereby facilitating the sheet 90 to conform to the forming mold details to achieve the desired shape. The present technique employs vacuum thermoforming process for forming the part. As will be appreciated by one skilled in the art other thermoforming techniques such as those employing air pressure and/or mechanical forming assists to move the softened sheet in contact with the shape of the forming mold are within the scope of the present technique.

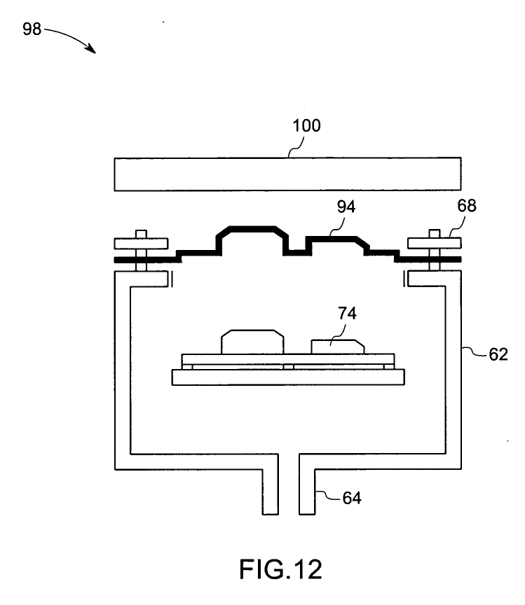

FIG. 12 is a diagrammatical illustration of an exemplary configuration 98 of the thermoforming system of FIG. 11 having a cooling device 100 for the formed part in accordance with aspects of the present technique. In the illustrated embodiment, the forming mold 74 is released and the formed part 94 is cooled via the cooling device 100. The cooled part 94 is subsequently removed from the thermoforming system 98. Further, the thermoformed part is trimmed to remove excess material. The trimming technique may be selected based upon factors such as part size, part geometry and material. Examples of two-dimensional trimming equipment include matched metal, hot and cold knife and die cutting. Examples of three-dimensional trimming equipment include five or six axis robot wielding laser and ultrasonic knife. Moreover, the flow-controlling material may be subsequently removed from the formed part 94.

Thus, the thermoformed part 94 formed by the exemplary process illustrated in FIGS. 3-12 includes at least one area of the thermoformed part 94 that is flow-controlled. This overall method of manufacturing achieves a localized control of thickness of the thermoformed part via the flow-controlling material.

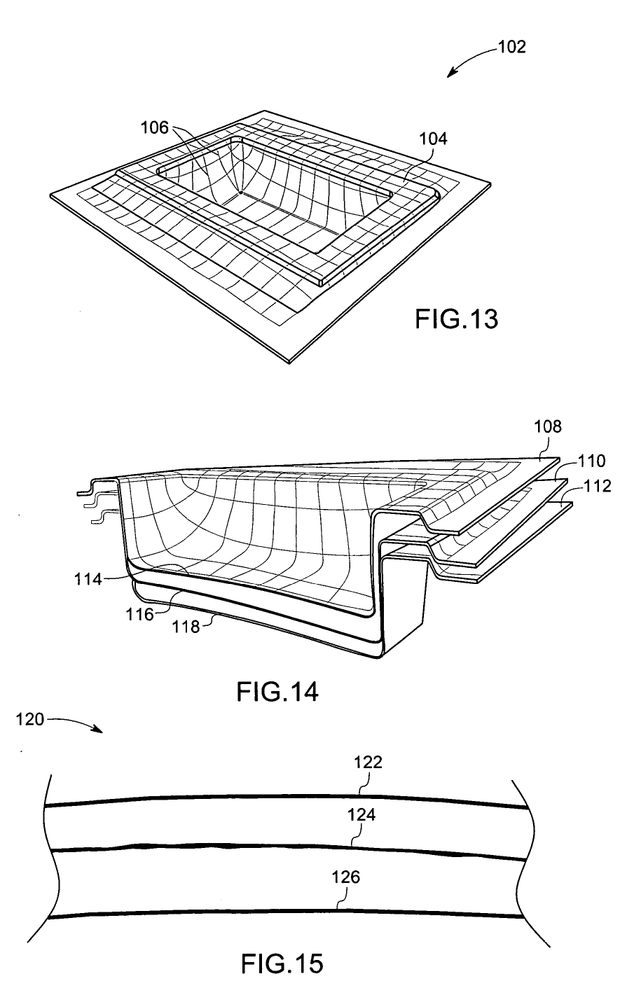

FIG. 13 is a diagrammatical representation of flow contours 102 of a material of a thermoformed part 104 manufactured by the thermoforming system of FIGS. 4-12 in accordance with aspects of the present technique. The flow of the material at different locations of the part 104 is represented by flow contours 106. As previously described, these flow contours 106 may be controlled via the flow-controlling material for controlling the thickness of the thermoformed part 104. FIG. 14 is a sectional view of exemplary thermoformed parts formed with and without masking of a sheet in accordance with aspects of the present technique. In the illustrated embodiment, three parts 108, 110 and 112 are formed via the thermoforming process. Further, a flow-controlling material was disposed on the preformed sheet for forming the parts 108 and 112 whereas the part 110 is thermoformed without the use of the flow-controlling material.

In the illustrated embodiment, the flow contours for surfaces 114, 116 and 118 are shown for the respective parts 108, 110 and 112. Further, areas corresponding to surfaces 114 and 118 are masked with the flow-controlling material on the respective preformed sheets to achieve a desired thickness profile on the surfaces 114 and 118. In a present embodiment, the masking material employed for thermoforming the part 108 is different than the masking material employed for thermoforming the part 112.

FIG. 15 is a diagrammatical illustration of a thickness distribution 120 of the thermoformed parts 108, 110 and 112 of FIG. 14 with and without the masking of the preformed sheet in accordance with aspects of the present technique. The thickness distribution for the surfaces 114, 116 and 118 is represented by contours 122, 124 and 126. As illustrated, the thickness of the surfaces 114 and 118 is greater than the thickness of the surface 116. Moreover, the thickness contours 122 and 126 for the thermoformed parts 108 and 112 formed by employing the flow-controlling material have a uniform thickness distribution along the surface as compared to the thickness contour 124 of the part 10 without the use of flow-controlling material. As will be appreciated by one skilled in the art a plurality of locations on a thermoformed part may be thickness controlled by utilizing the flow-controlling material to control the flow of material during the heating operation of the thermoforming process.

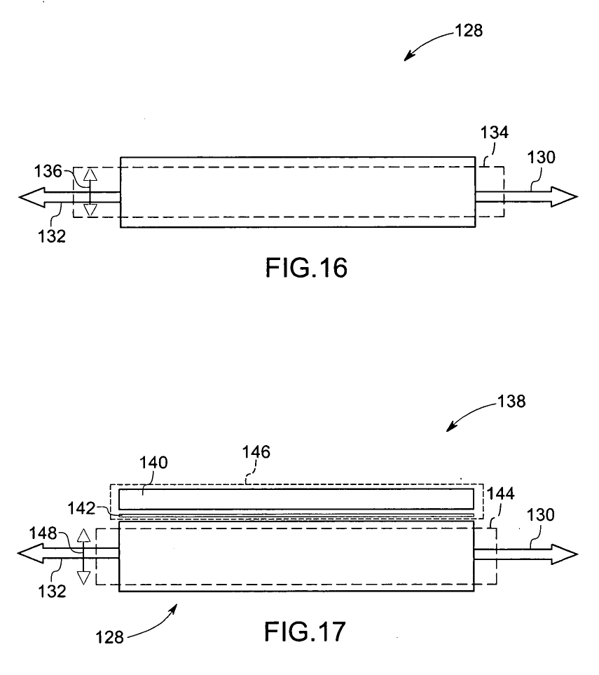

FIG. 16 is a diagrammatical illustration of an exemplary sheet 128 of FIG. 4 in accordance with aspects of the present technique. In the present embodiment, the sheet 128 is subjected to in-plane stretching during the thermoforming process as represented by directional arrows 130 and 132. As a result, the sheet 128 achieves a stretched configuration 134. Further, the thermoformed part formed by using the sheet 128 results in a thickness 136 of the part that may be lesser than a desired thickness due to the stretching of the sheet. The present technique employs the masking of the sheet to achieve the desired thickness as described below with reference to FIG. 17.

FIG. 17 is a diagrammatical illustration of a masked sheet 138 of FIG. 5 in accordance with aspects of the present technique. In the illustrated embodiment, the sheet 128 is masked with a flow-controlling material 140 on regions where thickness control is desired. The flow-controlling material 140 is coupled to the sheet 128 via an adhesive material 142. As illustrated, during the thermoforming process the sheet 128 is stretched in the stretch directions 130 and 132 to a stretched configuration 144. Similarly, the flow-controlling material 140 and the adhesive material 142 may be stretched to a stretched configuration 146. As will be appreciated by those skilled in the art the masking of the flow-controlling material 140 on the sheet 128 substantially prevents the material from flowing in the stretch directions 130 and 132 that leads to an increased thickness 148 of the final thermoformed part. As described earlier, based upon a desired thickness profile on the thermoformed part a masking profile may be determined that may be applied to the preformed sheet. Thus, a localized control may be achieved for the thermoformed part via controlling the flow of the material through the flow-controlling material 140.

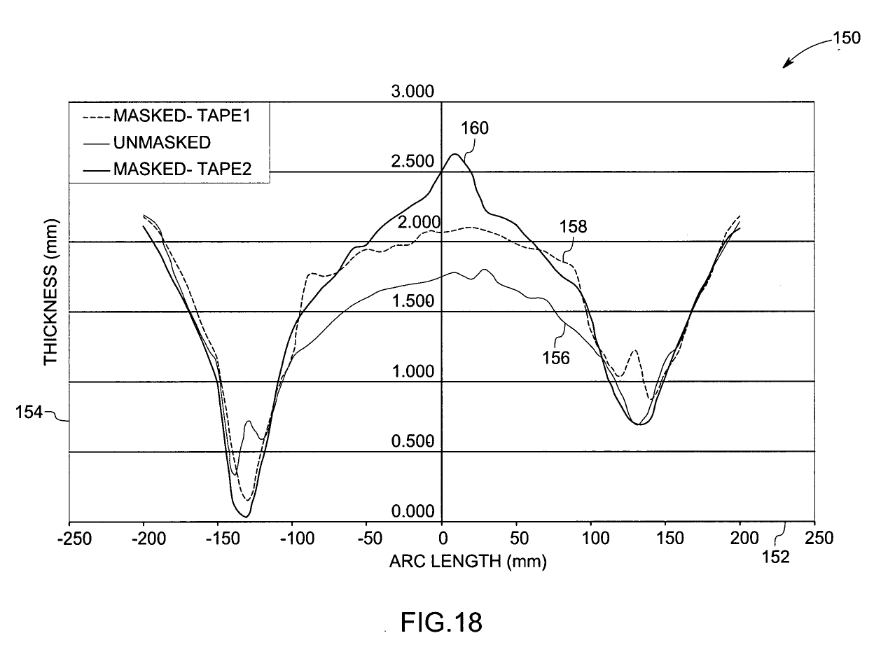

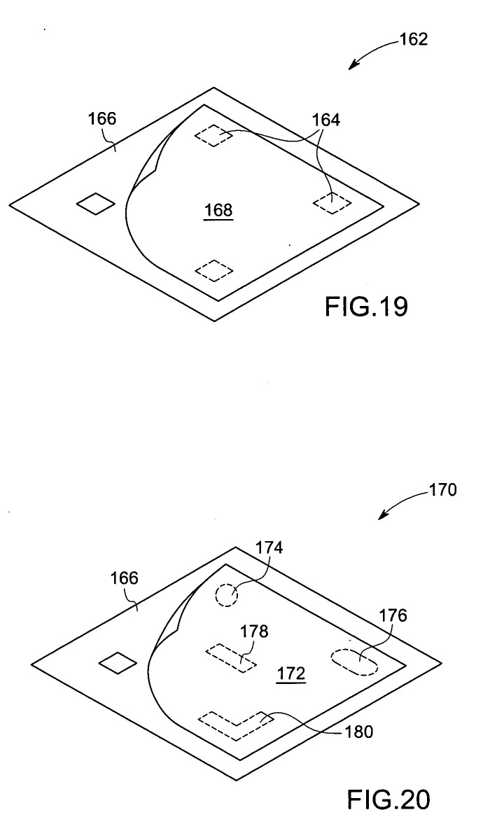

FIG. 18 is a graphical representation of exemplary thickness distribution 150 for thermoformed parts of FIG. 14 in accordance with aspects of the present technique. In the illustrated embodiment, the abscissa axis represents an arc length 152 over a section of the thermoformed parts 108, 110, 112 (see FIG. 14) and the ordinate axis represents an achieved thickness 154 for the thermoformed parts 108, 110 and 112. The thickness profile of the part formed without the masking of the preformed sheet is represented by 156. Further, the thickness profiles of the part formed by using the flow-controlling material on the preformed sheet are represented by contours 158 and 160. As illustrated, the contour 158 represents the thickness profile with a first flow-controlling material and the contour 160 represents the thickness profile with a second flow-controlling material. As can be seen, the thickness of the part formed with the masking materials is substantially higher than the thickness of the part formed without the masking material. It should be noted that the achieved thickness in the final thermoformed part depends upon factors such as the type of the flow-controlling material, stiffness of the flow-controlling material and the adhesion between the sheet and the flow-controlling material. The flow-controlling material may be applied on the preformed sheet through various techniques. FIGS. 19 and 20 illustrate exemplary configurations of the flow-controlling material for masking the sheet.

FIG. 19 is a diagrammatical illustration of an exemplary configuration 162 of a flow-controlling material 164 for masking a sheet 166 in accordance with aspects of the present technique. In the illustrated embodiment, a decal 168 is employed to apply the flow-controlling material 164 on the preformed sheet 166. As illustrated, the decal 168 includes a pre-determined pattern of the flow-controlling material 164 that is transferred to the preformed sheet 166. The pre-determined pattern of the flow-controlling material 164 may be determined based on a desired thickness profile on the final thermoformed part fabricated from the preformed sheet 166. It should be noted that the shape and orientation of the flow-controlling material 164 may be adjusted to achieve a desired thickness profile of the thermoformed part.

FIG. 20 is a diagrammatical illustration of another exemplary configuration 170 of a flow-controlling material for masking the sheet 166 in accordance with aspects of the present technique. As illustrated, a decal 172 is employed to transfer the flow-controlling material to the sheet 166. In the illustrated embodiment, the decal 172 includes a plurality of patterns of the flow-controlling material such as 174, 176, 178 and 180 disposed on the decal 172. In an exemplary embodiment, each of these patterns 174, 176, 178 and 180 has a different shape an orientation at different locations based on the desired thickness profile on such regions. For example, patterns 174 and 176 have circular and oval shape respectively. Similarly, patterns 178 and 180 have a rectangular and an L-shape respectively. However, different patterns having different shapes, sizes and orientations may be envisaged for the thickness control in the thermoformed part from the preformed sheet 166.

As illustrated above, a substantially accurate thickness control may be achieved in a thermoformed part by utilizing the present technique. The present technique may also be advantageously utilized to facilitate thickness control in other parts manufactured via various other manufacturing processes. For example, the above technique may be used in controlling thickness of parts in a blow molding process.

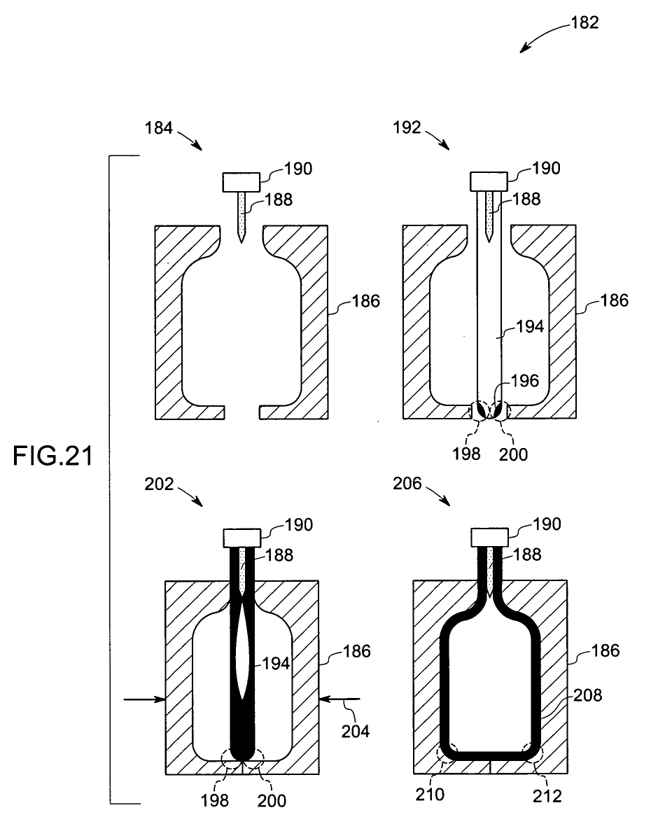

FIG. 21 is a diagrammatical illustration of a blow-molding process 182 for forming a part in accordance with aspects of the present technique. The blow-molding process 182 processes a plastic tubular form that may be produced by extrusion or injection molding. In the illustrated embodiment, the plastic tubular form is produced by extrusion molding. As illustrated at step 184, the exemplary configuration of the blow molding apparatus includes a mold 186 for forming the part. The blow molding apparatus also includes a blow pin 188 and an extruder 190. At step 192, the plastic is extruded between the two halves of the mold 186 to create a parison or tube 194 via the extruder 190. Further, a flow-controlling material 196 may be disposed on a plurality of locations such as 198 and 200 for controlling the flow of material in these locations 198 and 200 for achieving a desired thickness profile.

At step 202, the parison 194 is softened inside the mold 186 and is subsequently injected with air or other compressed gas 204. This air or compressed gas 204 expands the parison 200 against the sides of the mold cavity 186. Subsequently, at step 206 the parison 194 forms a hollow part 208 conforming to the size and shape of the mold 186. It should be noted that the flow controlling material 196 applied on the pre-determined locations 198 and 200 in the parison 194 facilitates thickness control at corresponding locations 210 and 212 in the part 208.

The various aspects of the method described hereinabove have utility in different applications. The technique illustrated above may be used for controlling the thickness of thermoformed parts for use in different applications. For example, the technique may be used to control the thickness of thermoformed parts for automobiles, household appliances such as refrigerators and so forth. Further, the technique may be employed to provide an enhanced thickness control of parts fabricated by other techniques such as blow molding. In particular, the present technique is advantageous to provide an accurate clearance control in formed parts by controlling the flow of material during the forming process.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for thermoforming a part, comprising:
cutting a blank;
masking at least one side of a desired surface of the blank with a flow-controlling material;
heating the masked blank to a forming temperature; and
forming the blank to achieve a desired contour of the part.

2. The method of claim 1, further comprising trimming the formed part.

3. The method of claim 1, further comprising removing the flow-controlling material from the formed part.

4. The method of claim 1, comprising controlling a thickness of the formed part in the at least one side of the surface of the blank.

5. The method of claim 1, comprising identifying a plurality of locations on the surface of the blank and mapping the plurality of locations on the blank.

6. The method of claim 5, wherein the masking of the blank comprises coupling the flow-controlling material to the pre-determined locations on the blank via an adhesive material.

7. A method of controlling a thickness of a thermoformed part, comprising:
identifying at least one location on a blank for controlling the thickness of the thermoformed part;
mapping the at least one location on the blank;
controlling the thickness of the at least one location on the blank via a flow-controlling material disposed on the at least one location; and
thermoforming the blank to create the thermoformed part.

8. The method of claim 7, further comprising removing the flow-controlling material from the thermoformed part.

9. The method of claim 7, further comprising controlling an orientation of the flow-controlling material disposed on the blank.

11. The method of claim 7, wherein thermoforming comprises forming the part in vacuum.

12. A thermoformed part having a three-dimensional contour, wherein at least one area of the three-dimensional contour is flow-controlled via a flow-controlling material to achieve a desired thickness profile of the at least one area.

13. The thermoformed part of claim 12, wherein the flow-controlling material is applied to a blank in the at least one area via an adhesive material.

14. The thermoformed part of claim 13, wherein the blank having the flow-controlling material is heated and formed to achieve the desired thickness profile.

15. A flow-controlling device for thermoforming of a part, comprising:
a flow-controlling material disposed on a sheet-like support and configured to control flow of a material at pre-determined locations on the sheet-like support during thermoforming of the part; and
an adhesive material disposed on at least the flow-controlling material and configured to couple the flow controlling material to the sheet-like support.

16. The flow-controlling device of claim 15, wherein the melting temperature of the flow-controlling material is greater than the melting temperature of the material of the part.

17. The flow-controlling device of claim 15, wherein the device is configured to control a thickness at the pre-determined locations on the thermoformed part.

18. The flow-controlling device of claim 17, wherein the device is configured for controlling a thickness profile of a blow-molded part.

19. The flow-controlling device of claim 15, wherein an orientation of the flow-controlled material is adjusted to achieve a desired thickness profile at the pre-determined locations.

20. A system for controlling a thickness of a thermoformed part, comprising:
means for controlling the flow of the material of the blank disposed at a location on the blank where thickness is to be controlled; and
means for thermoforming the blank to achieve a desired contour of the thermoformed part.

21. The method of claim 20, further comprising means for identifying the at least one location on the blank where thickness control is desired.
